(19) United States
(12) Patent Application Publication
(10) Pub. No.: US 2013/0022010 A1
(43) Pub. Date: Jan. 24, 2013

(54) Method and Apparatus for Managing Inter-Cell Interference for Device-to-Device Communications

(71) Applicants: Lu Qianxi, Beijing (CN); Tao Peng, Beijing (CN); Haiming Wang, Beijing (CN); Tao Chen, Espoo (FI)

(72) Inventors: Lu Qianxi, Beijing (CN); Tao Peng, Beijing (CN); Haiming Wang, Beijing (CN); Tao Chen, Espoo (FI)

(73) Assignee: NOKIA CORPORATION, Espoo (FI)

(21) Appl. No.: 13/638,398

(22) PCT Filed: Apr. 6, 2010
(86) PCT No.: PCT/CN10/71569

§ 371 Date: Sep. 28, 2012

(51) Int. Cl. H04W 72/08

(52) U.S. Cl. 370/329

(57) ABSTRACT

A method, apparatus, and computer program can provide inter-cell interference management. The method, for example, may generate an inter-cell assistance information to facilitate a selection of one or more physical resource blocks for device-to-device communications based at least in part on a scheduling or interference information exchanged between a plurality of nodes. The method can further comprise transmitting the generated inter-cell assistance information to a plurality of user equipments in device-to-device communication mode. The inter-cell assistance information may comprise at least one physical resource block, or additionally at least one source node identity associate with the at least one physical resource block, or additionally at least one destination node identity associated with the at least one physical resource block and the at least one source node identity.

### TECHNICAL FIELD

The present application relates generally to mechanisms that support wireless communications, and, more particularly, relate to a method and apparatus for managing inter-cell interference for direct device-to-device communications.

### BACKGROUND

In many cellular communication systems, a communication mode utilizes a base station to establish and control communications between wireless communication devices such as mobile stations carried by subscribers. Accordingly, a base station acts as an intermediary relay link between the wireless communication devices. In this conventional communication mode, each wireless communication device communicates with another wireless communication device employing communication paths between each communication device and the base station, for example, each wireless communication device indirectly communicates with the other wireless communication device. However, due to the potential for increased data transfer rates and increased system bandwidth, system designers are now considering the implementation of ad-hoc networks, or device-to-device (D2D) networks, together with cellular communications systems to generate hybrid systems. Such a D2D network enables a direct communication path or link between wireless communication devices. As an example, the direct communication path or link, is referred to as a device-to-device (“D2D”) communication path or link.

Currently the third generation partnership project (“3GPP”) has started the standardization work for direct D2D communication integrated into a cellular network in the LTE/LTE-A (Long Term Evolution/Long Term Evolution-Advanced). As presently specified the downlink access technique utilizes Orthogonal Frequency Division Multiple Access (OFDMA), and the uplink access technique utilizes Single Carrier-Frequency Division Multiple Access (SC-FDMA).

### SUMMARY

Various aspects of examples of the invention are set out in the claims.

According to a first aspect of the present invention, provide an apparatus, comprising: at least one processor; and at least one memory including computer program code; the at least one memory and the computer program code configured to, with the at least one processor, cause the apparatus to perform at least the following: generating an inter-cell assistance information to facilitate a selection of one or more physical resource blocks for device-to-device communications, said inter-cell assistance information being generated based at least in part on a scheduling or interference information exchanged between a plurality of base stations; and transmitting said generated inter-cell assistance information to a plurality of devices for device-to-device communications.

According to a second aspect of the present invention, provide a method, comprising: generating an inter-cell assistance information, to facilitate a selection of one or more physical resource blocks for device-to-device communications, said inter-cell assistance information being generated based at least in part on a scheduling or interference information exchanged between a plurality of base stations; and transmitting said generated inter-cell assistance information to a plurality of devices for device-to-device communications.

According to a third aspect of the present invention, provide an apparatus, comprising: at least one processor; and at least one memory including computer program code; the at least one memory and the computer program code configured to, with the at least one processor, cause the apparatus to perform at least the following: receiving an inter-cell assistance information at a device-to-device communication device; and selecting one or more physical resource blocks for a device-to-device communication based on at least one of said received inter-cell assistance information and local measurement results. According to a fourth aspect of the present invention, provide a method, comprising: receiving an inter-cell assistance information at a device-to-device communication device; and selecting one or more physical resource blocks for a device-to-device communication based on at least one of said received inter-cell assistance information and local measurement results.

According to a fifth aspect of the present invention, provide a computer program, comprising: code for generating an inter-cell assistance information to facilitate a selection of one or more physical resource blocks for device-to-device communications, said inter-cell assistance information being generated based at least in part on a scheduling or interference information exchanged between a plurality of base stations; and code for transmitting said generated inter-cell assistance information to a plurality of devices for device-to-device communications; when the computer program is run on a processor.

According to a sixth aspect of the present invention, provide a computer program, comprising: code for receiving an inter-cell assistance information at a device-to-device communication device; and code for selecting one or more physical resource blocks for a device-to-device communication based on at least one of said received inter-cell assistance information and local measurement results; when the computer program is run on a processor.

### BRIEF DESCRIPTION OF THE DRAWINGS

For a more complete understanding of example embodiments of the present invention, reference is now made to the following descriptions taken in connection with the accompanying drawings in which:

FIG. 1 illustrates a hybrid device-to-device (D2D) and cellular communications system according to various example embodiments of the invention;

FIG. 2 illustrates a simplified block diagram of certain apparatus for managing D2D inter-cell interference according to various example embodiments of the present invention;

FIG. 3 illustrates an example flow diagram showing operations for D2D inter-cell interference management according to an example embodiment of the invention;

FIG. 4 illustrates an example flow diagram showing operations for D2D inter-cell interference management according to another example embodiment of the invention;

FIG. 5a illustrates an example table for inter-cell assistance information format according to an example embodiment of the present invention;

FIG. 5b illustrates another example table for inter-cell assistance information format according to another example embodiment of the present invention;

FIG. 5c illustrates yet another example table for inter-cell assistance information format according to yet another example embodiment of the present invention; and

FIG. 6 illustrates an example signaling diagram for implementing D2D inter-cell interference management according to an example embodiment of the present invention.

### DETAILED DESCRIPTION OF THE DRAWINGS

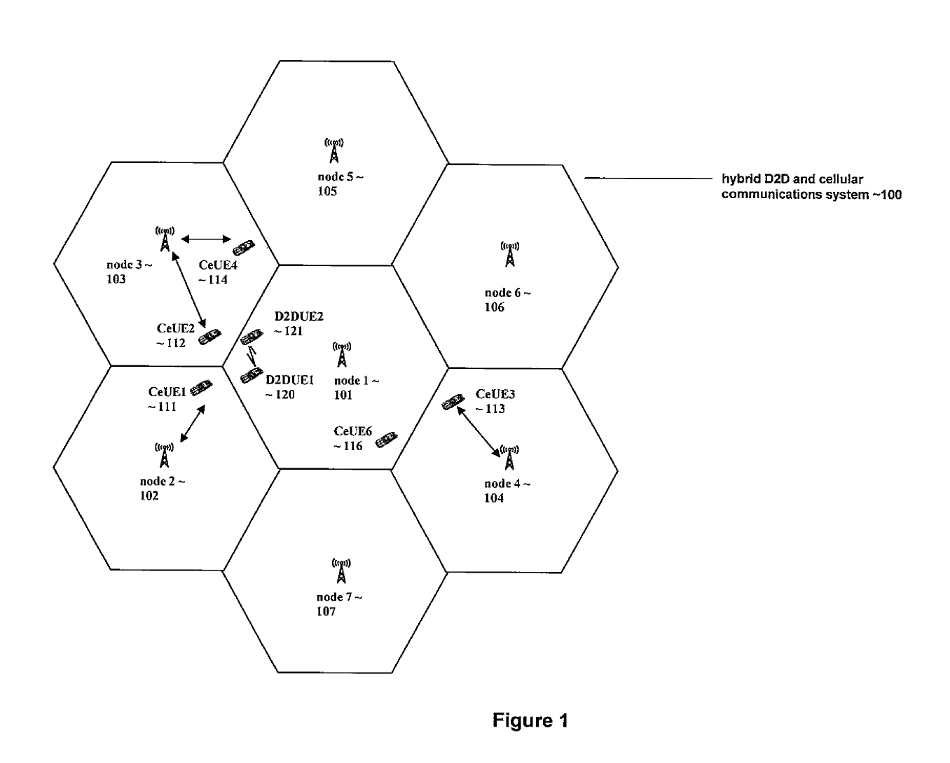

An example embodiment of the present invention and its potential advantages are understood by referring to FIG. 1 through FIG. 6 of the drawings.

An apparatus, method, and software for managing inter-cell interference for direct device-to-device communications are disclosed. Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The terms “data,” “content,” “information,” and similar terms may be used interchangeably, according to some example embodiments of the present invention, to refer to data capable of being transmitted, received, operated on, and/or stored.

Although the embodiments of the invention are discussed with respect to a Third Generation Partnership Project (3GPP) Long Term Evolution (LTE) or Long Term Evolution-Advanced (LTE-A) system, the embodiments of the invention have applicability to any type of hybrid communication systems for device-to-device (D2D) communication integrated cellular network and equivalent systems.

FIG. 1 illustrates a hybrid device-to-device (D2D) and cellular communications system 100 according to various example embodiments of the invention. The system 100 comprises a node 101, its neighbor nodes 102˜107, and a plurality of UEs, e.g., D2DUE1 120, D2DUE2 121, CeUE1 111, CeUE2 112, CeUE3 113, CeUE4 114 and CeUE6 116. The node 101 and its neighbor nodes 102˜107 may be configured as any type of access point or base station that supports cellular communications. For example, the node 101 may be configured as an eNodeB (eNB) within a Long-Term Evolution (LTE) communications system. The cellular communications may utilize Frequency Division Duplexing (FDD) or Time Division Duplexing (TDD). Node 101 and its neighbor nodes 102˜107 may also be configured to facilitate or otherwise allow the implementation of supporting D2D communications.

The UEs may be any type of mobile station, such as handsets, terminals, stations, units, devices, or any type of interface to the user, such as “wearable” circuitry, etc., configured to implement cellular communications, such as LTE/LTE-A. For example, CeUE1 111, CeUE2 112, CeUE3 113, CeUE4 114 and CeUE6 116 are depicted as currently being in cellular communications with other UEs via their own serving node, e.g. 102, 103, 104, 103, 101 separately. The UEs may also be configured to support D2D communications. D2D communications may involve direct communications between two UEs or relay communications via UEs. In an example embodiment, the D2D communications may be implemented using FDD or TDD. In this regard, D2DUE1 120, D2DUE2 121 are depicted in FIG. 1 as being in communication via a D2D communications session. D2DUE2 121 is currently the transmitting UE in the D2D communication session and D2DUE1 120 is currently the receiving UE in the D2D communications session.

The portion of the hybrid network 100 that operates in the cellular communication mode utilizes the node 101, and possibly other nodes, such as any of the nodes 102˜107 as a centralized controller. As the centralized controller, the node 101 may be involved in all communications within the node's cell. As such, node 101 may provide for resource control and interference control for cellular communications within the cell. The node 101 may also provide for the controlling of interference between cells for cellular communications. In an example embodiment, the interference caused between cells is called inter-cell interference.

When UEs are near each other, or a D2D connection is otherwise possible, increasingly efficient communications may be achieved by using the D2D connection. For example, communications via the cellular communication mode may require twice the resource utilization due to the communications between the UEs and the node. Additionally, D2D communications may also achieve higher data rates between the UEs, while reducing the communications load on the node. Accordingly, hybrid networks, of the type depicted in FIG. 1 may provide improved system performance.

Since UEs in the hybrid network 100 may operate in either D2D mode or in cellular communication mode, frequency resources may be shared between the modes. Due to this sharing of resources, interference on shared resources may occur within the system when simultaneous communications are conducted in the cellular mode and the D2D mode. The use of omni-directional antennas by the UEs may further increase the likelihood of interference. The interference may come from inside one single cell, or between different cells at the cell edge. In an example embodiment, the interference that comes from inside one single cell is called intra-cell interference. In an example embodiment, the interference that comes from between different cells at the cell edge is called inter-cell interference.

Referring to FIG. 1, D2DUE1 120 and D2DUE2 121 in the D2D communications are located at the cell edge of the node 101. D2DUE2 121 is currently the transmitting UE and D2DUE1 120 is currently the receiving UE in the D2D communications session. If the UEs, such as CeUE4 114, CeUE2 112, CeUE3 113 and CeUE1 111, are located at the cell edge of the node 101's neighbor nodes, such as node 103, node 104, and node 102, inter-cell interference may occur to the UEs in the D2D communication mode, such as D2DUE1 120 and D2DUE2 121. Since CeUE2 112 and CeUE4 114 are near the edge of the node 103 and CeUE1 111 is near the edge of the node 102, the signal transmitted by CeUE2 112 in the neighbor node 103 or CeUE1 111 in the neighbor node 102 may increasingly interfere with the D2D communications between D2DUE2 and D2DUE1 in the node 101, especially for the reception at D2DUE1 120.

If the receiving UE, such as D2DUE1 120, reuses CeUE2's or CeUE1's frequency resources in D2D communication mode, the reception of D2DUE1 120 may suffer from the associated inter-cell interference from the transmission of CeUE2 or CeUE1, and the performance of D2DUE1 120's communications may be degraded. However, in some instances, reuse of resources may not be as problematic. For example, since CeUE3 113 located at the cell edge of node 104, or CeUE4 114 is far away from the receiving D2DUE1 120, inter-cell interference to D2DUE1 120 from CeUE3 113 or CeUE4 may be insignificant and thus ignored. In this regard, if the receiving D2DUE1 120 reuses the resources allocated to CeUE3 113 or CeUE114, rather than the resource allocated to CeUE2 112, or CeUE1 111, the inter-cell interference to the receiving D2DUE1 120 may be reduced greatly.

In the 3GPPLTE or LTE-A system, the access node, such as base station, or similar devices, e.g., Node B or eNode B, allocates the resources to UEs in the cellular communication mode in a dynamic way, for example, by 1 ms TTI basis, which means the interference caused by the cellular communication is dynamic or time-varying. Furthermore, in the example of FIG. 1, at the cell edge, the interference is caused by, such as CeUE2 and CeUE4 in the cellular communications, which are scheduled by node 101's neighbor node 103, and caused by CeUE6 in the cellular communications, which are scheduled by its serving node 101. To adapt to the time-varying cellular scheduling, a mechanism of blind interference avoidance via learning or predicting may be used. Thus, the future cellular interference environment may be predicted from previous cellular scheduling behavior. This kind of scheme works well in a slow-varying and more regular scheduling pattern. In a D2D system, the cellular scheduling is highly dynamic. Thus, the D2D blind interference avoidance by learning or predicting is not so effective in such systems. Especially, since UEs in D2D communication mode adapt to the dynamic interference environment to implement D2D communication at the cell edge.

According to some example embodiments, UEs in D2D communication mode manage the inter-cell interference in an autonomous fashion with the assistance from a cellular node. Example embodiments of the present invention provide mechanisms for facilitating a UE's selection of resources for utilization in D2D communications to lessen or avoid inter-cell interference with cellular communications. According to some example embodiments, UEs in D2D communication mode share or reuse the uplink spectrum of cellular system with the cellular UEs.

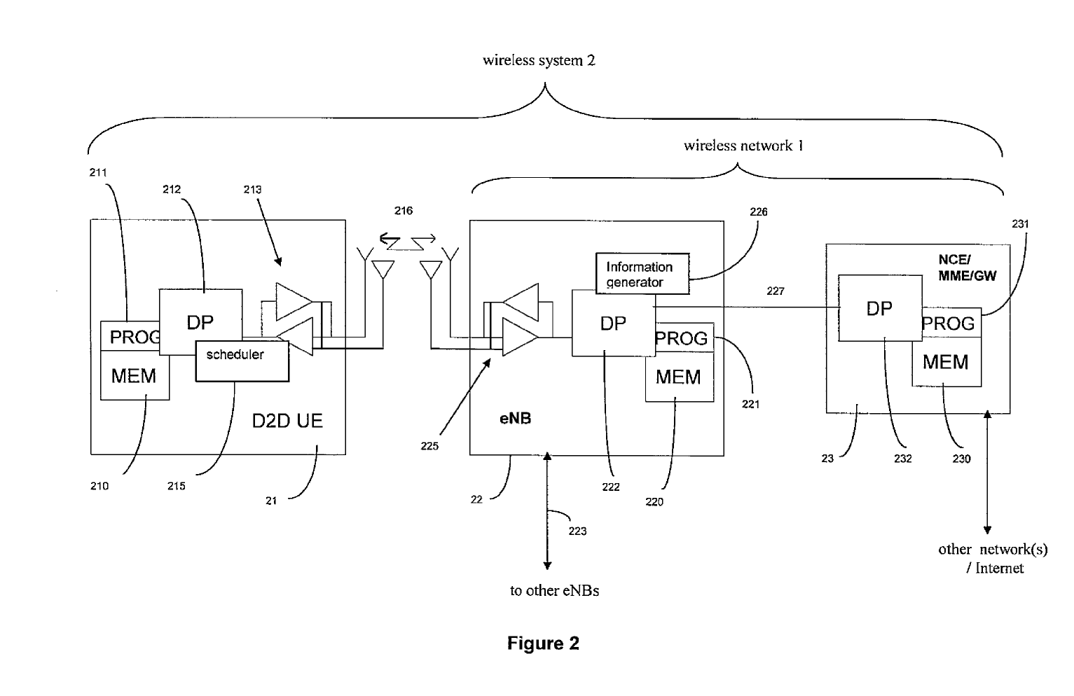

FIG. 2 illustrates a simplified block diagram of a wireless system 2 for managing D2D inter-cell interference according to various example embodiments of the present invention. A wireless network 1 is adapted for communication over a wireless link 216 with an apparatus 21 via a network access node, such as eNB 22. Apparatus 21 may be a mobile communication device in cellular communication mode, or a mobile communication device in a D2D communication mode. The mobile communication device in cellular communication mode may be, for example, CeUE1 111, CeUE2 112, CeUE3 113, CeUE4 114 and CeUE6 116, of FIG. 1. The mobile communication device in D2D communication mode may be, for example, D2DUE1 120 and D2DUE2 121, of FIG. 1.

eNB 22 may have control over its own cells. The network 1 comprises a network control element (NCE) 23 that may comprise MME/S-GW (Mobility Management Entity/Serving Gateway) functionality, and provide connectivity with another broader network, such as a telephone network and/or a data communications network, e.g., the internet. The apparatus UE 21 comprises at least one processor, such as a data processor (DP) or controller 212, at least one computer-readable storage medium embodied as at least one memory (MEM) 210 that stores a program of computer instructions or codes (PROG) 211, and a suitable radio frequency (RF) transceiver 213 for bidirectional wireless communications with the eNB 22 via one or more antennas.

The eNB 22 also comprises at least a processor, such as data processor (DP) or controller 222, at least one computer-readable memory medium embodied as at least one memory (MEM) 220 that stores a program of computer instructions or codes (PROG) 221, and a suitable RF transceiver 225 for communication with the UE 21 via one or more antennas. The eNB 22 is coupled via a data/control path 227 to the NCE 23. The path 227 may be implemented as an SI interface. The eNB 22 may also be coupled to another eNB via data/control path 223, which may be implemented as an X2 interface.

At least one of the PROGs 211 and 221 comprises program instructions that, when executed by the associated DP, enable the device to operate in accordance with the example embodiments of this invention, as will be discussed below in greater detail.

The example embodiments of this invention may be implemented at least in part by computer software executable by the DP 212 of the UE 21 and/or by the DP 222 of the eNB 22, or by hardware, or by a combination of software and hardware and firmware.

For the purposes of describing the example embodiments of this invention the UE 21 may be assumed to be a UE in D2D communication mode, and also comprise a scheduler 215, and the eNB 22 may comprise an information generator 226. The information generator 226 generates an inter-cell assistance information to facilitate a selection of one or more physical resource blocks for device-to-device communications according to the example and non-limiting embodiments detailed below. The scheduler 215 selects one or more physical resource blocks for a device-to-device communication based on at least one of said received inter-cell assistance information and local measurement results communications according to the example and non-limiting embodiments detailed below.

In general, the various embodiments of the UE 21 can include, but are not limited to, cellular telephones, devices in D2D communication mode, personal digital assistants (PDAs) having wireless communication capabilities or D2D communication capabilities, portable computers having wireless communication capabilities or D2D communication capabilities, image capture devices such as digital cameras having wireless communication capabilities or D2D communication capabilities, gaming devices having wireless communication capabilities or D2D communication capabilities, music storage and playback appliances having wireless communication capabilities or D2D communication capabilities, Internet appliances permitting wireless Internet access and browsing, as well as portable units or terminals that incorporate combinations of such functions.

The computer readable MEMs 210 and 220 may be of any type suitable to the local technical environment and may be implemented using any suitable data storage technology, such as semiconductor based memory devices, flash memory, magnetic memory devices and systems, optical memory devices and systems, fixed memory and removable memory. The DPs 212 and 222 may be of any type suitable to the local technical environment, and may comprise one or more of general purpose computers, special purpose computers, microprocessors, digital signal processors (DSPs) and processors based on a multicore processor architecture, as non-limiting examples.

According to various example embodiments of inter-cell interference avoidance, a node e.g., node 101 may assist UEs in D2D communication mode in the selection of resources. In this regard, based at least in part on scheduling or interference information exchanged between a plurality of base stations via X2 interface, a node may generate an inter-cell assistance information and send the inter-cell assistance information, via broadcasting or dedicated signaling, to UEs in D2D communication mode within the associated cells for selection of resources. The UEs in D2D communication mode may receive the inter-cell assistance information and use such information to make autonomous D2D communication scheduling, such as whether reusing the resources of cellular UEs at the cell edge, and the like, so as to lessen or avoid harmful inter-cell interference with the receiving UE in D2D communication mode.

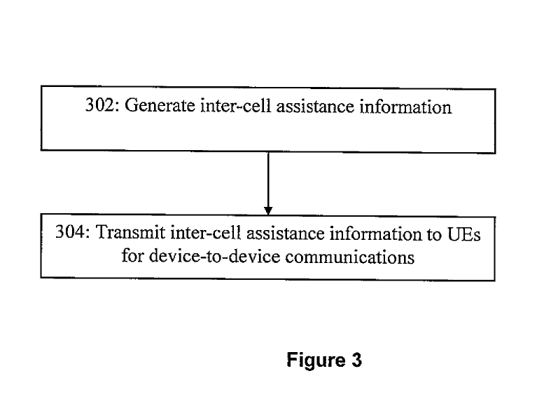

FIG. 3 illustrates an example flow diagram showing operations for D2D inter-cell interference management according to an example embodiment of the invention. It illustrates the operation of a method, and actions performed by a processor at the eNodeB as a result of executing a computer program stored on a computer readable memory, in accordance with the example embodiments of this invention.

At block 302, inter-cell assistance information is generated. In an example embodiment, the inter-cell assistance information facilitates a selection of one or more physical resource blocks for device-to-device communications. At block 304, the generated inter-cell assistance information is transmitted to a plurality of UEs in device-to-device communication mode, for example, D2DUE1 120 and D2DUE2 121 of FIG. 1.

In an example embodiment at block 302, the inter-cell assistance information is generated based at least in part on a scheduling or interference information exchanged between a plurality of nodes, such as base stations, for example, between node 101 and its neighbor nodes 102˜107 of FIG. 1. For example, the scheduling or interference information exchanged between a plurality of base stations via X2 interface, also referred to as X information, may comprise at least one of a high interference indication (HII) and an overload indication, as what have already been discussed in the 3GPP LTE/LTE-A contribution R1-074477. The HII indicates the PRBs, in which the serving eNode B schedules cell edge UEs, that will cause high inter-cell interference. Thus these PRBs will be most sensitive to inter-cell interference. In case of overload, the eNode B may send to its neighbour eNode Bs an overload indicator (OI) via X2 interface for the purpose of uplink power control. In an example embodiment, the signaling of HII and OI is triggered by an event, and with the delay of about 20 ms on X2 interface. For the minimum frequency granularity, each PRB may have one corresponding HII and OI. If desired, the signaling of HII or OI may be sent through neighbor-cell specific contents to the different neighbor cells. Inter-cell Interference Coordination (ICIC) approach is an example of the signaling of HII or OI. In the ICIC approach, uplink inter-cell interference may be avoided in advance by proactive indication exchange through BS-to-BS interface. The ICIC approach in the 3GPP LTE/LTE-A contribution R1-074477 aims to solve the inter-cell interference within the cellular system. In the cellular system, the resource scheduling entity is located at the eNode B. eNode B schedules the resource allocations to the cellular UEs in its cells based on the HII or OI signaling via X2 interface. Hence, the HII or OI signaling does not need to be sent to the cellular UEs in the cellular communications. With the introduction of D2D communications integrated into cellular communications system, the resource scheduling entity for a UE in D2D communication mode is located at the UE side. Thus, in order to support D2D autonomous scheduling, UEs in D2D communication mode receive assistance information from eNB to have an effective resource scheduling or selection.

In another example embodiment, the generating inter-cell assistance information of block 302 comprises refining the scheduling or interference information exchanged between the plurality of base stations. The refining may comprise, for example, trimming or filtering the unnecessary information with respect to UEs in D2D communication mode under the serving eNB; adding more useful information with respect to UEs in D2D communication mode under the serving eNB; and/or the like.

In an example embodiment, the serving node of UEs in D2D communication mode may send an inter-cell assistance information to the UEs in D2D communication mode in order that UEs in D2D communication mode can make autonomous scheduling in D2D communication mode. If a neighbor node of a serving node schedules UEs at its cell edge in at least one PRB, the scheduled UE might cause high interference on the at least one PRB. Information is needed to indicate whether a UE using a PRB at the cell edge will cause high interference on that PRB or not. In this regard, an inter-cell assistance information may comprise at least one information indicating, whether at least one physical resource block in which a neighbor base station schedules cell edge UEs, will cause high inter-cell interference. An inter-cell assistance information may comprise at least one information indicating at least one PRB in which cell edge UEs causing high inter-cell interference are scheduled by a neighbor base station. The PRB may be indexed by a PRB index. For example, if CeUE4 114, located at the node edge of node 103, is scheduled in PRB5, than PRB5 will be indicated as the PRB which might cause high inter-cell interference to the neighbor cells of CeUE4 114. Similarly, for example, if CeUE3 113, located at the node edge of node 104, is scheduled in PRB4, then PRB4 will be indicated as the PRB which might cause high inter-cell interference to the neighbor cells of CeUE3 113.

Further, in some example embodiments of the inter-cell assistance information, the inter-cell assistance information may further comprise at least one source node identity associated with at least one PRB. In an example embodiment, the source node identity is the identity of the node from which the inter-cell interference associated with the at least one PRB comes from. The source node may be a neighbor node of a serving node in which a UE in D2D communication mode is located in and the neighbor node schedules the at least one PRB for the UEs at its cell edge. For example, D2DUE1 120 and D2DUE2 121 are in D2D communications in the serving node 101. CeUE3 113 is located at the cell edge of the node 104, which is node 101's neighbor node. The transmission of CeUE3 113 might bring interference to the receiving UEs in D2D communication mode in the node 101, such as D2DUE1 120. In this example, node 104 is one of the source nodes that the inter-cell interference comes from.

Similarly, node 103, at whose edge CeUE4 114 and CeUE2 112 are located is another source node that may bring inter-cell interference to the receiving UEs in D2D communication mode in node 101. This kind of source node identity in the inter-cell assistance information may provide the UEs in D2D communication mode in the serving node more information which may improve the performance of D2D autonomous scheduling.

In some example embodiments, the inter-cell assistance information may further comprise at least one destination node identity associated with at least one physical resource block and at least one source node identity. In an example embodiment, the destination node identity is the identity of the node to which the source node sends X information via X2 interface. The X information is associated with the at least one PRB that is scheduled to the UEs at the cell edge of the source node. The UEs located at the cell edge of the source node may cause high interference to the destination node. For example, CeUE4 114, located at the cell edge of node 103, is scheduled in PRB5. PRB5 will be indicated in the inter-cell assistance information as the PRB which might cause high inter-cell interference to the neighbor cells of CeUE4 114. The node 103 is denoted as the source node in the same inter-cell assistance information that might bring interference in PRB5 to UEs in D2D communication mode. CeUE4 114 is located near both node 101 and node 105, so PRB5, which CeUE4 114 is scheduled in, might bring high inter-cell interference to UEs in D2D communication mode in both node 101 and node 105. Thus the existence of CeUE4 114 will influence the scheduling of node 101 and node 105. In this regard, node 103 will send X information with respect to the inter-cell interference information via X2 interface to only node 101 and node 105, not to node 102. Node 101 and node 105 are denoted as the destination node in the same inter-cell assistance information that the interference information associated with the scheduled UE will send to from the source node. The serving node, for example node 101, of UEs in D2D communication mode, for example, D2DUE1 120, will signal at least one source node identity, such as node 103, and also at least one destination node identity, such as node 105, in an inter-cell assistance information to UEs in D2D communication mode in the serving node, e.g. node 101. If the destination node is the same with the serving node, then in an example embodiment, the destination node is not comprised in the inter-cell assistance information by the serving node. In this example, node 101 does not comprise itself as destination node in the inter-cell assistance information, because node 101 is a default destination node. The destination node identity, together with source node identity, and PRB index that the associated cell edge UE is scheduled in, may provide UEs in D2D communication mode in the serving node more information. This may improve the performance of the D2D autonomous scheduling.

In an example embodiment, at block 304, the generated inter-cell assistance information is transmitted to the UEs in D2D communication mode via broadcasting or via physical downlink control channel, such as PDCCH in LTE/LTE-A, or non-limiting signaling schemes.

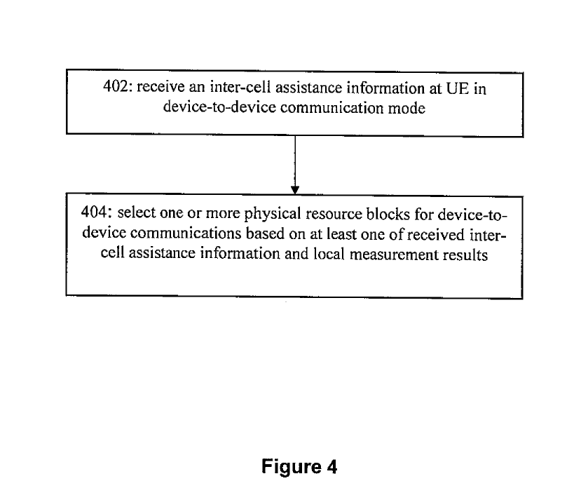

FIG. 4 illustrates an example flow diagram showing operations for D2D inter-cell interference management according to another example embodiment of the invention. It illustrates the operation of a method, and actions performed by a processor at a UE in D2D communication mode, for example D2DUE1 120 of FIG. 1, as a result of executing a computer program stored on a computer readable memory, in accordance with the example embodiments of this invention.

At block 402, an inter-cell assistance information is received at a UE in D2D communication mode. At block 404, one or more physical resource blocks for the D2D communication are selected based on at least one of said received inter-cell assistance information and local measurement results.

In an example embodiment at block 404, the local measurement comprises the measurement of a reference signal received power (RSRP) at the UE in D2D communication mode. In an example embodiment, the RSRP is measured based on at least one of cell specific reference signals and positioning reference signals (PRS) of neighbor nodes. The local measurement may be utilized to track geographical location for the UE or determine a neighbor cell list for the UE.

As an example, the receiving D2DUE1 120 will determine its neighbor cell to be one or more cells of node 102 and node 103 by making RSRP measurement. The RSRP measurement is made based on the cell specific reference signals after decoding neighbor cell broadcasting information. The neighbor cell broadcasting information is received via cell searching procedure in the cell edge area. The RSRP measurement may be made based on the positioning reference signals from the neighbor cells. The PRS is more interference-free reference signal than cell specific reference signal in the cell edge area.

Similar as the UEs in D2D communication mode, UEs in cellular communication mode may also determine their neighbor cell list by using a similar scheme. In an example embodiment, CeUE4 will determine cells of node 101 and node 105 as its neighbor cell by making measurement of RSRP at the UE based on cell specific reference signals and/or positioning reference signals of node 101 and node 105.

In an example embodiment at block 404, the local measurement may further comprise interference measurement at a UE in D2D communication mode. The UE may be scheduled in at least one PRB. The interference measurement may be, made corresponding to each PRB in which the UE is scheduled. The indexes of the at least one PRB are indicated in the information in the inter-cell assistance information. UEs in a source node scheduled in that at least one PRB may bring high interference to the receiving UEs in D2D communication mode in its serving node.

In an example embodiment at block 404, selecting one or more physical resource blocks in D2D communication mode comprises determining whether reusing at least one physical resource block indicated in the inter-cell assistance information or not. As discussed before, inter-cell assistance information is used to indicate whether a UE at the neighbor cell edge may cause high inter-cell interference on the PRBs scheduled to the UE. If inter-cell assistance information indicates that high inter-cell interference might be caused on the PRBs, the UE in D2D communication mode will take further measurement. The PRBs which might cause high inter-cell interference may still be reused if a UE in D2D communication mode is far way from the UE using those PRBs. In this scenario, the actual inter-cell interference caused to the UE in D2D communication mode is low because of long distance between the UE in D2D communication mode and the UE using those PRBs. In this regard, in a first example embodiment, at least one physical resource block is reused in case the actual inter-cell interference caused on those at least one physical resource block is lower than a predefined threshold. In a second example embodiment, the at least one physical resource block is reused in case no interference is actually caused on those at least one physical resource block. In a third example embodiment, the at least one physical resource block is not reused in case the inter-cell interference actually caused on those at least one physical resource block exceeds a predefined threshold.

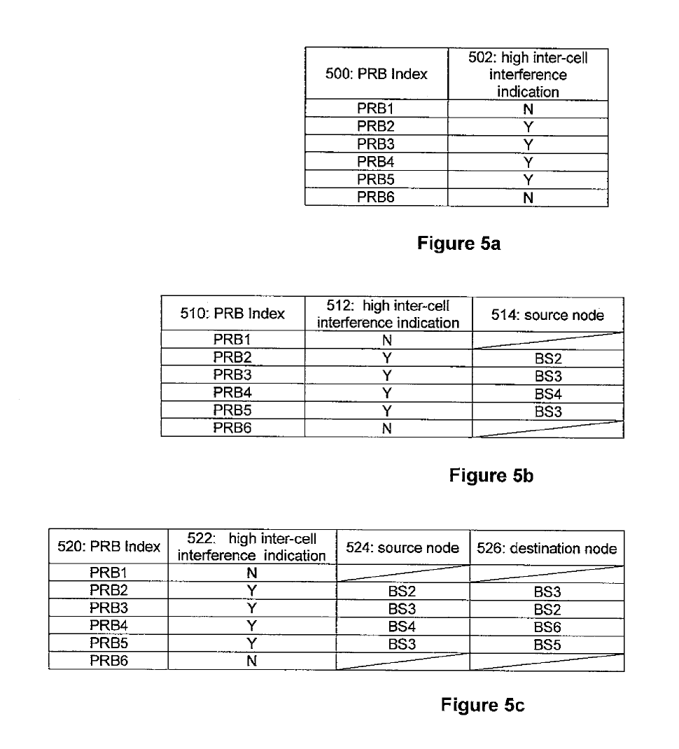

FIG. 5a through FIG. 5c illustrate tables showing example formats for inter-cell assistance information.

FIG. 5a illustrates an example table for inter-cell assistance information format. It provides a simplified table where the inter-cell assistance information may comprise a field of PRB index 500 and a field of high inter-cell interference indication 502. The field of high inter-cell interference indication indicates whether the associated PRB might cause high inter-cell interference to the receiving UEs in D2D communication mode in a serving node. In an example embodiment, a one-bit indication may be used. In such an embodiment, a value “Y” may indicate that high inter-cell interference might be caused to the receiving UEs in D2D communication mode in the serving node, while a value “N” may indicate no inter-cell interference might be caused to the receiving UEs in D2D communication mode in the serving node. In the table of FIG. 5a, the first example format is illustrated for a system bandwidth of 6 PRBs. In an example embodiment, the inter-cell assistance information that a UE in D2D communication mode receives indicates that high inter-cell interference might be caused on PRB2, PRB3, PRB4, and PRB5, In this example format, the UE in D2D communication mode, such as D2DUE1 120 of FIG. 1 can only reuse PRB1 and PRB 6.

FIG. 5b illustrates another example table for inter-cell assistance information format. In addition to the information provided in the example table depicted in FIG. 5a, in the example table of FIG. 5b, the information may further comprise an identity of a source node 514. The source node 514 is the node where the inter-cell interference on the associated PRB 510 comes. Thus the inter-cell assistance information format in this example embodiment may comprise a field for PRB index 510, a field for high inter-cell interference indication 512, and a source node identity 514. In the table of FIG. 5b, the second example format is illustrated for a system bandwidth of 6PRBs. In an example embodiment, the inter-cell assistance information that a UE in D2D communication mode receives indicates that high inter-cell interference might be caused on PRB2, PRB3, PRB4, and PRB 5. However, not all cellular UEs located at the cell edge of the source node will cause high interference to the receiving UEs in D2D communication mode, e.g. D2DUE1 120 of FIG. 1, in its serving node. This is due to the different location of the source node from which X information is sent to the D2DUE1's serving node. Hence, the receiving UE in D2D communication mode has to distinguish the location of itself and the source node where the inter-cell interference comes from. Thus by using the additional information of the source node identity, the receiving UE in D2D communication mode may improve the performance of the resource reuse, or avoid the unnecessary loss of the resource reusing opportunity.

D2DUE1 120 of FIG. 1 is located near node 103 and node 102. The node 102 and node 103 are determined as neighbor nodes of D2DUE1 120 based on the local measurement by D2DUE1 120. Other nodes will not be determined as the neighbor nodes of D2DUE1 120. In an example embodiment, the inter-cell interference associated with PRB2 comes from node 102. The inter-cell interference associated with PRB3 comes from node 103. The inter-cell interference associated with PRB4 comes from node 104. And the inter-cell interference associated with PRB5 comes from node 103. D2DUE1 120 will not determine node 104 as its neighbor node, because CeUE3 113 that schedules on PRB4 is far away from D2DUE1 120. So PRB 4 may be reused by D2DUE1 120.

In the second example format, the UE acquires more useful information about the resource scheduling in the neighbor cells than the first example format, so the UE in D2D communication mode, such as D2DUE1 120, can reuse not only PRB1 and PRB 6, but also PRB4. Instead of using source node identity, in another alternative example embodiment, D2DUE1 120 may take RSRP measurement to track geographical location of the CeUE3 which is using PRB4. The PRB4 can be reused if the location of D2DUE1 120 and CeUE3 is sufficiently far away from each other based on the RSRP measurement.

FIG. 5c illustrates yet another example table for inter-cell assistance information format. In addition to the information provided in the example table depicted in FIG. 5b, in the example table of FIG. 5c, the information may further comprise an identity of a destination node 526, to which a source node 524 sends X information via X2 interface. The X information is associated with the at least one PRB 520 that is scheduled to the UEs at the cell edge of the source node. The UEs located at the cell edge of the source node may cause high interference to the destination node. Thus the inter-cell assistance information format in this example embodiment may comprise a field for PRB index 520, a field for high inter-cell interference indication 522, a field for source node identity 524, and a field for destination node identity 526.

In the table of FIG. 5c, the third example format is illustrated for a system bandwidth of 6 PRBs. In an example embodiment, the inter-cell assistance information that a UE in D2D communication mode receives indicates that high inter-cell interference might be caused on PRB2, PRB3, PRB4, and PRB 5. However, not all cellular UEs located at the cell edge of the source node will cause high interference to the receiving UEs in D2D communication mode, e.g. D2DUE1 120. This is due to the different location of the source node from which X information is sent to D2DUE1's serving node. Thus by using the additional information of destination node identity, the receiving UE in D2D communication mode may further improve the performance of the resource reuse, or to avoid the unnecessary loss of the resource reusing opportunity.

CeUE4 114 of FIG. 1 is located at the edge of node 103, and CeUE4 114 is also next to node 101 but far from the receiving D2DUE1 120. The scheduling of CeUE4 114 in the node 103 however causes no or low interference to D2DUE1 120 due to the large distance between them. This kind of resource reuse cannot be identified by the second information format without destination node information. In an example embodiment, D2DUE1 120 receives the inter-cell assistance information. The inter-cell assistance information indicates that CeUE4 114 who schedules PRB5 might cause high interference to D2DUE1 120. The inter-cell assistance information further indicates that the source node of CeUE4 is node 103 and the destination node of CeUE4 is node 105. By using the source node and destination node information, D2DUE1 120 may derive that CeUE4 is located in the area near node 105 and node 103, but far away from D2DUE1 120 whose neighbor cells are under node 102 and node 103. Thus PRB5 is reused at D2DUE1 120. In the third example format, UE acquires more useful information about the resource scheduling in the neighbor cells than the first two example formats, so the UE in D2D communication mode, such as D2DUE1 120, can reuse not only PRB1, PRB4 and PRB 6, but also PRB5. In addition, D2DUE1 120 may make further interference measurements for scheduling enhancement.

In another example embodiment, interference measurement of CeUE4 114 is enabled at the receivers of D2DUE1 120. In an example embodiment, the received inter-cell assistance information will be further filtered by the receiving D2DUE1 120. Although the inter-cell assistance information denotes a potential cellular interference, if no or low interference is observed by the receiving D2DUE1 120, the corresponding resources can still be reused by the receiving D2DUE1 120. However, in this example embodiment, some further interference measurement on these resources would be needed.

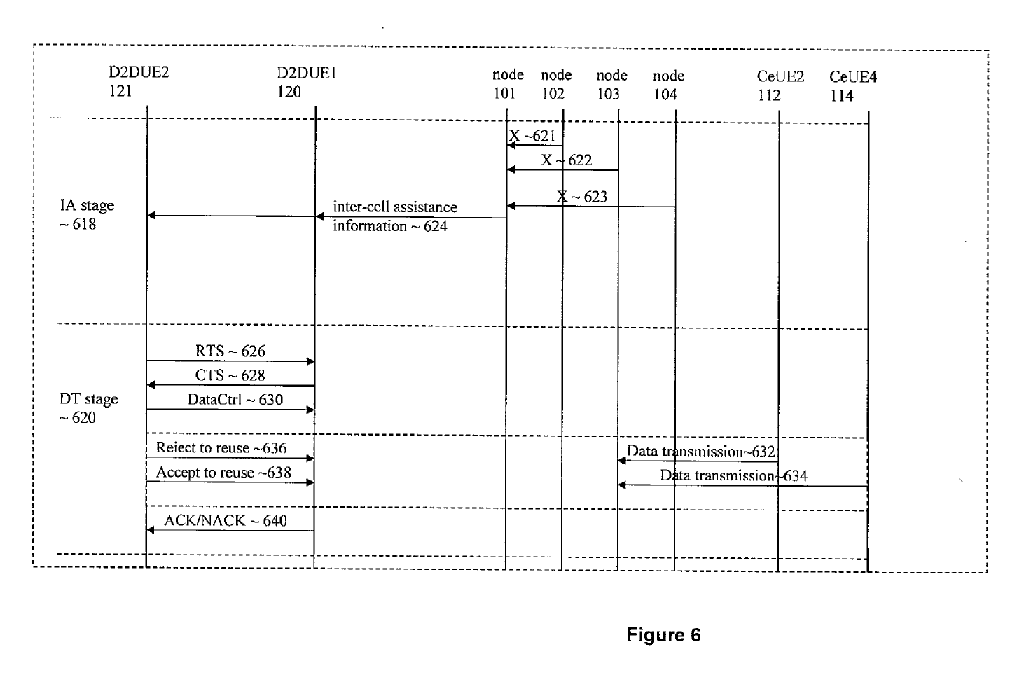

FIG. 6 illustrates an example signaling diagram for implementing D2D inter-cell interference management according to an example embodiment of the present invention. It provides an example embodiment of signaling diagram for implementing D2D inter-cell interference management in D2D handshake procedure. The following detailed procedure uses a LTE/LTE-A like system for illustration purposes only.

The procedure may be divided into two functional stages, with the first stage of information acquisition 618 (IA), and the second stage of data transmission 620 (DT). An example handshake mechanism is illustrated. However, the invention is not limited only to the illustrated example.

In an example embodiment, during information acquisition 618 (IA), X information is exchanged between nodes. For example, at 621, node 102 of FIG. 1 sends X information to node 101 of FIG. 1 through BS-to-BS signaling. At 622, node 103 sends X information to node 101 through BS-to-BS signaling. At 623, node 104 sends X information to node 101 through BS-to-13S signaling.

Then the node 101 processes the received X information, generates and sends the inter-cell assistance information 624 to UEs in D2D communication mode, such as D2DUE2 121 and D2DUE1 120 of FIG. 1. The serving node 101 may send the inter-cell assistance information to UEs in D2D communication mode as soon as possible. For example, the serving node 101 may send the inter-cell assistance information to D2DUE2 121 and D2DUE1 120 when X information has been received and the inter-cell assistance information has been generated. The inter-cell assistance information may be transmitted on part of physical downlink control channel (PDCCH). The inter-cell assistance information may be sent via broadcasting or dedicated signaling.

In an example embodiment, data transmission (DT) 620 comprises the implementation of carrier sense multiple access with collision avoidance (CSMA/CA) with request to send/clear to send (RTS/CTS) in the hybrid system of D2D communications and cellular communications. In an example embodiment, D2DUE2 121 sends RTS message 626 to D2DUE1 120 to request resources for their D2D communications. D2DUE1 120 sends CTS message 628 to D2DUE2 121 as a response to the received RTS message 626. Data control signal, for example DataCtrl 630, is sent by the transmitting D2DUE2 121 to the receiving D2DUE1 120. Information in the DataCtrl 630 is used for D2D data detection and decoding.

In an example embodiment, CeUE2 112 in cellular communication mode is performing data transmission 632 to node 103 of FIG. 1. CeUE2 114 in cellular communication mode is also performing data transmission 634 to node 103. The data transmission of CeUE2 112 and CeUE4 114 may cause inter-cell interference to receiving UEs in D2D communication mode in their neighbor nodes, such as D2DUE1 120 in node 101.

In an example embodiment, D2DUE2 121 may send a message of reject to reuse 636 to D2DUE1 120. Then D2DUE1 120 in D2D communication mode may not reuse the resource allocated to CeUE2 112 in cellular communication mode in the neighbor node 103.

In an example embodiment, D2DUE2 121 may send a message of accept to reuse 638 to D2DUE1 120. Then D2DUE1 120 in D2D communication mode may reuse the resource allocated to CeUE4 114 in cellular communication mode in the neighbor node 103.

In an example embodiment, after D2DUE1 120 receives the message of reject to reuse 636 or accept to reuse 638, it sends an acknowledge/non-acknowledge (ACK/NACK) message 640 to D2DUE2 121 according to its received message.

Without in any way limiting the scope, interpretation, or application of the claims appearing below, a technical effect of one or more of the example embodiments disclosed herein is to provide support of autonomous D2D scheduling with the assistance of cellular controller in the hybrid network. Another technical effect of one or more of the example embodiments disclosed herein is to lessen or avoid the inter-cell interference during autonomous D2D scheduling. Another technical effect of one or more of the example embodiments disclosed herein is to provide the resource reusing efficiency in the hybrid network. Another technical effect of one or more of the example embodiments disclosed herein is to provide backward compatibility of the release 8 LTE UEs.

Embodiments of the present invention may be implemented in software, hardware, application logic or a combination of software, hardware and application logic. The software, application logic and/or hardware may reside on an apparatus, such as base station or mobile station, or reside on an apparatus in the base station or mobile station. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-46. (canceled)

47. A method, comprising:
generating an inter-cell assistance information, to facilitate a selection of one or more physical resource blocks for device-to-device communications, said inter-cell assistance information being generated based at least in part on a scheduling or interference information exchanged between a plurality of nodes; and
transmitting said generated inter-cell assistance information to a plurality of user equipments in device-to-device communication mode.

48. The method according to claim 47, wherein said inter-cell assistance information comprises at least one of:
at least one information indicating, whether at least one physical resource block in which a neighbor node schedules cell edge user equipments, will cause high inter-cell interference;
at least one source node identity associated with said at least one physical resource block; and
at least one destination node identity associated with said at least one physical resource block and said at least one source node identity.

49. An apparatus, comprising:
at least one processor; and
at least one memory including computer program code;
the at least one memory and the computer program code configured to, with the at least one processor, cause the apparatus to:
generate an inter-cell assistance information to facilitate a selection of one or more physical resource blocks for device-to-device communications, said inter-cell assistance information being generated based at least in part on a scheduling or interference information exchanged between a plurality of nodes; and
transmit said generated inter-cell assistance information to a plurality of user equipments in device-to-device communication mode.

50. The apparatus according to claim 49, wherein said inter-cell assistance information comprises at least one information indicating, whether at least one physical resource block in which a neighbor node schedules cell edge user equipments, will cause high inter-cell interference.

51. The apparatus according to claim 50, wherein said inter-cell assistance information further comprises at least one source node identity associated with said at least one physical resource block.

52. The apparatus according to claim 51, wherein said inter-cell assistance information further comprises at least one destination node identity associated with said at least one physical resource block and said at least one source node identity.

53. The apparatus according to claim 49, wherein the scheduling or interference information exchanged between said plurality of nodes comprises at least one of a high interference indication and an overload indication, wherein said high interference indication is indicative of one or more physical resource blocks in which a neighbor node schedules cell edge user equipments causing high inter-cell interference, and wherein said overload indication is indicative of overload of a neighbor node.

54. The apparatus according to claim 49, wherein the at least one memory and the computer program code are configured to, with the at least one processor, cause the apparatus at least to generate said inter-cell assistance information by refining the scheduling or interference information exchanged between the plurality of nodes.

55. The apparatus according to claim 49, wherein the at least one memory and the computer program code are configured to, with the at least one processor, cause the apparatus to transmit said generated inter-cell assistance information by broadcasting said generated inter-cell assistance information.

56. The apparatus according to claim 49, wherein the at least one memory and the computer program code are configured to, with the at least one processor, cause the apparatus to transmit said generated inter-cell assistance information via physical downlink control channel.

57. A computer program, comprising:
code for generating an inter-cell assistance information to facilitate a selection of one or more physical resource blocks for device-to-device communications, said inter-cell assistance information being generated based at least in part on a scheduling or interference information exchanged between a plurality of nodes; and
code for transmitting said generated inter-cell assistance information to a plurality of user equipments in device-to-device communication mode;
when the computer program is run on a processor.

58. A method, comprising:
receiving an inter-cell assistance information at a user equipment in device-to-device communication mode; and
selecting one or more physical resource blocks for a device-to-device communication based on at least one of said received inter-cell assistance information and local measurement results.

59. The method according to claim 58, wherein the inter-cell assistance information comprises at least one of:
at least one information indicating whether at least one physical resource block in which a neighbor node schedules cell edge user equipments, will cause high inter-cell interference;
at least one source node identity associated with said at least one physical resource block;
at least one destination node identity associated with said at least one physical resource block and said at least one source node identity.

60. An apparatus, comprising:
at least one processor; and
at least one memory including computer program code;
the at least one memory and the computer program code configured to, with the at least one processor, cause the apparatus to:
receive an inter-cell assistance information at user equipment in device-to-device communication mode; and
select one or more physical resource blocks for a device-to-device communication based on at least one of said received inter-cell assistance information and local measurement results.

61. The apparatus according to claim 60, wherein the inter-cell assistance information comprises at least one information indicating whether at least one physical resource block in which a neighbor node schedules cell edge user equipments, will cause high inter-cell interference.

62. The apparatus according to claim 61, wherein said inter-cell assistance information further comprises at least one source node identity associated with said at least one physical resource block.

63. The apparatus according to claim 62, wherein said inter-cell assistance information further comprises at least one destination node identity associated with said at least one physical resource block and said at least one source node identity.

64. The apparatus according to claim 60, wherein the local measurement comprises at least one of:
measurement of reference signal received power at said user equipment in device-to-device communication mode based on at least one of cell specific reference signals and positioning reference signals of neighbor cells; and
interference measurement at said user equipment in device-to-device communication mode on the physical resource blocks indicated in said information in the inter-cell assistance information.

65. The apparatus according to claim 60, wherein the local measurement is utilized to track geographical location for said user equipment or determine a neighbouring cell list for said user equipment.

66. The apparatus according to claim 60, wherein the at least one memory and the computer program code are also configured to, with the at least one processor, cause the apparatus to select one or more physical resource blocks for the device-to-device communication by one of:
reusing the at least one physical resource block in case the actual inter-cell interference caused on the at least one physical resource block is lower than a predefined threshold;
reusing the at least one physical resource block in case no interference is actually caused on the at least one physical resource block; and
not reusing the at least one physical resource block in case the inter-cell interference actually caused on the at least one physical resource block exceeds a predefine threshold.
